(19) United States
(12) Patent Application Publication
(10) Pub. No.: US 2026/0011959 A1
(43) Pub. Date: Jan. 8, 2026

(54) CONNECTOR ASSEMBLY WITH U-SHIELD AND GROUND PLATE

(71) Applicant: Molex, LLC, Lisle, IL (US)

(72) Inventors: Marc E Krause, Darien, IL (US); Scott Edwards, Little Rock, AR (US); Jose J. Gonzalez, Jr., Joliet, IL (US); Edward Elms, Bloomingdale, IL (US); Eugene Callaghan, Lisle, IL (US); Jerber Mendoza, Aurora, IL (US); John C. Laurx, Aurora, IL (US)

(21) Appl. No.: 18/881,737

(22) PCT Filed: Aug. 10, 2023
(86) PCT No.: PCT/IB2023/058106

§ 371 Date: Jan. 7, 2025

Related U.S. Application Data
(60) Provisional application No. 63/371,210, filed on Aug. 11, 2022.

(51) Int. Cl. H01R 13/6585; H01R 13/6471

(52) U.S. Cl. CPC H01R 13/6585; H01R 13/6471

(57) ABSTRACT

An electrical connector is described that can be employed in mezzanine applications. In one example, a wafer in the electrical connector includes a ground shield, terminals that extend within the ground shield, an insulative frame, and a cover plate. The ground shield includes side walls that define a channel. A first ground shield terminal lead and a second ground shield lead terminal together form a ground shield terminal pair positioned at a first end of the wafer. A first signal terminal and a second signal terminal together form a terminal pair nested in the channel. The insulative frame retains the ground shield and the terminal pair, and the cover plate is electrically coupled to the ground shield and extends over the channel.

### CROSS-REFERENCE TO RELATED APPLICATION

This application claims the benefit of and priority to U.S. Provisional Patent Application No. 63/371,210 filed Aug. 11, 2023 entitled “CONNECTOR ASSEMBLY,” the contents of which being incorporated by reference in their entirety herein.

### BACKGROUND

For high data rate applications in which physical space is constrained, as one example, it can be challenging to design interconnection system connectors due to a number of competing concerns. High data rate interconnection systems often rely upon differentially coupled signal pairs in which two conductors are arranged in a pair to transmit a differential signal. The signal being transmitted is embodied by the electrical difference measured between the conductor pair. Differential signaling can be helpful to avoid spurious signals and crosstalk, and avoid inadvertent signaling modes among adjacent signals pairs. In connector interfaces, ground terminals can be relied upon to create a return path to electrical ground, provide shielding between differential pairs, and for other purposes.

Connectors used in high data rate applications are typically designed to meet a range of mechanical and electrical requirements. High data rate connectors are often used in backplane applications, as one example, that require very high conductor density and data rates. To achieve the desired mechanical and electrical requirements, the connectors used in such applications often incorporate one or more wafer assemblies. The wafer assemblies may include an insulative web that supports the terminal conductors in the wafer assemblies. The use of wafer assemblies can be helpful to manufacture connectors capable of achieving high data rates using a number of different assembly processes. It is still challenging, in any case, to design wafers having the conductor density and small footprint needed for high data rate applications in new systems, while also maintaining the desired electrical characteristics for the transmission of data with integrity.

### TECHNICAL FIELD

The present disclosure relates to the field of connectors suitable for use in high data rate applications.

### BRIEF SUMMARY

According to various aspects, an electrical connector is described. In a first aspect, an electrical connector is described, including: a wafer assembly including a plurality of wafers, wherein at least one of the plurality of wafers includes: a ground shield having side walls that define a channel, the ground shield including a first ground shield terminal lead and a second ground shield lead terminal that together form a ground shield terminal pair positioned at a first end of the at least one of the wafers, and a ground shield tail positioned at a second end of the at least one of the wafers; a first signal terminal and a second signal terminal together forming a terminal pair nested in the channel, the first signal terminal and the second signal terminal each having a terminal lead at the first end disposed between the ground shield terminal pair, and a terminal tail positioned at the second end; an insulative frame that retains the ground shield and the terminal pair; and a cover plate electrically coupled to the ground shield and extending over the channel.

The channel is a U-shaped channel, the cover plate is positioned laterally with respect to a midpoint of one of the plurality of wafers, and the insulative frame and the U-shaped channel together define a plurality of apertures. The cover plate covers at least one of the plurality of apertures. The at least one of the plurality of apertures covered by the plurality of apertures is a respective aperture closest to the terminal lead of the terminal pair.

The ground shield tail is a single ground shield tail in a one-to-two correspondence with the terminal tail of the first signal terminal and the second signal terminal. The terminal pair is one of a plurality of terminal pairs; the ground shield is one of a plurality of ground shields; in a first portion of the terminal pairs, the ground shield tail of the plurality of ground shields is a single ground shield tail in a one-to-two correspondence with the terminal tail of the first signal terminal and the second signal terminal; and in a second portion of the terminal pairs, the ground shield tail of the plurality of ground shields is one of two ground shield tails in a two-to-two correspondence with the terminal tail of the first signal terminal and the second signal terminal.

The insulative frame includes a plurality of projections that form an interference fit or a friction fit with a plurality of apertures positioned on a bottom surface of the ground shield. The at least one of the plurality of wafers further includes: a connecting member separate from the terminal pair positioned parallel to the terminal pair, wherein the connecting member includes a plurality of teeth configured to engage with corresponding teeth of the insulative frame. The connecting member is one of a plurality of connecting members.

The terminal pair is one of a plurality of terminal pairs, and a first portion of the plurality of connecting members are positioned outside of and parallel to a first distal one of the terminal pairs, and a second portion of the plurality of connecting members are positioned outside of and parallel to a second distal one of the terminal pairs. The connector is a hermaphroditic connector configured to detachably attach to another connector separate from and identical to the connector.

The insulative frame extends into the channel such that the signal terminals are each encapsulated by the insulative frame, wherein the insulative frame maintains the signal terminals a predetermined distance above a bottom surface of the ground shield and a predetermined distance from side walls of the ground shield. The insulative frame maintains each of the signal terminals a predetermined distance from one another. The insulative frame further includes separation members extending downwardly relative to a body of the insulative frame, wherein the separation members are positioned between the ground shield and another adjacent ground shield. The separation members extend downwardly below a bottom surface of the ground shield.

In a second aspect, an electrical connector is described, including: at least one wafer, the at least one wafer including a first signal terminal and a second signal terminal together forming a terminal pair, the first signal terminal and the second signal terminal each having a terminal lead at a first end of the at least one wafer, and a terminal tail positioned at a second end of the at least one wafer opposite the first end; and a ground shield having side walls that define a U-shaped channel in which the terminal pair are nested, the ground shield including a first ground shield terminal lead and a second ground shield lead terminal that together form a ground shield terminal pair positioned at the first end of the at least one of the wafers, and a ground shield tail positioned at the second end of the at least one of the wafers. The ground shield includes sidewalls having a multitude of notches symmetrically opposed from one another, wherein the notches are cut-out sections provided in the side walls, the notches being configured to engage and retain an insulative frame and a cover plate to the at least one wafer.

The cover plate is positioned laterally with respect to a midpoint of the at least one wafer, the insulative frame and the U-shaped channel together define a plurality of apertures, and the cover plate covers at least one of the plurality of apertures. The at least one of the plurality of apertures covered by the plurality of apertures is a respective aperture closest to the terminal lead of the terminal pair.

The terminal pair is one of a plurality of terminal pairs; the ground shield is one of a plurality of ground shields; in a first portion of the terminal pairs, the ground shield tail of the plurality of ground shields is a single ground shield tail in a one-to-two correspondence with the terminal tail of the first signal terminal and the second signal terminal; and in a second portion of the terminal pairs, the ground shield tail of the plurality of ground shields is one of two ground shield tails in a two-to-two correspondence with the terminal tail of the first signal terminal and the second signal terminal.

The at least one wafer further includes a connecting member separate from the terminal pair positioned parallel to the terminal pair, wherein the connecting member includes a plurality of teeth configured to engage with corresponding teeth of the insulative frame; the terminal pair is one of a plurality of terminal pairs; a first portion of the plurality of connecting members are positioned outside of and parallel to a first distal one of the terminal pairs; and a second portion of the plurality of connecting members are positioned outside of and parallel to a second distal one of the terminal pairs.

In other aspects, methods for providing or using any combination of the foregoing electrical connectors, or portions thereof, are disclosed.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a top perspective view of an electrical connector in accordance with various embodiments of the present disclosure.

FIG. 2 is another top perspective view of an electrical connector in accordance with various embodiments of the present disclosure.

FIG. 3 is a bottom perspective view of an electrical connector in accordance with various embodiments of the present disclosure.

FIG. 4 is an exploded perspective view of an electrical connector in accordance with various embodiments of the present disclosure.

FIG. 5 is a top cross-section view of an electrical connector in accordance with various embodiments of the present disclosure.

FIG. 6 is a top plan view of a wafer assembly portion of an electrical connector in accordance with various embodiments of the present disclosure.

FIGS. 7 and 8 are enlarged front perspective views of a wafer of an electrical connector in accordance with various embodiments of the present disclosure.

FIGS. 9 and 10 are enlarged rear perspective views of a wafer of an electrical connector in accordance with various embodiments of the present disclosure.

FIG. 11 is a top perspective view of a ground shield for use in an electrical connector in accordance with various embodiments of the present disclosure.

FIG. 12 is a top perspective view of signal connectors for use in an electrical connector in accordance with various embodiments of the present disclosure.

FIG. 13 is a side perspective view of signal connectors and an insulative frame for use in an electrical connector in accordance with various embodiments of the present disclosure.

FIG. 14 is a top partial transparency view of a wafer for use in an electrical connector in accordance with various embodiments of the present disclosure.

FIG. 15 is an enlarged cross-section view of a rear portion of a wafer for use in an electrical connector in accordance with various embodiments of the present disclosure.

### DETAILED DESCRIPTION

The present disclosure relates to the field of connectors suitable for use in high data rate applications. Computer, networking, and telecommunication equipment often have designs requiring complicated printed circuit board (PCB) and integrated circuit (IC) routing along with expensive multilayered boards that increase costs of various applications. The connector described herein allows personnel to simplify IC and PCB routing without sacrificing performance and while further enabling personnel to avoid the expense of large, complex multilayer boards.

According to various embodiments, an electrical connector is described that includes a wafer assembly having a multitude of wafers stacked relative to one another, for example, in a stacked arrangement. One or more of the wafers includes a ground shield having side walls that define a channel. The ground shield includes a first ground shield terminal lead and a second ground shield lead terminal that together form a ground shield terminal pair positioned on a first end of the at least one of the wafers. The ground shield further includes a ground shield tail positioned on a second end of the at least one of the wafers.

The electrical connector further includes a first signal terminal and a second signal terminal together forming a terminal pair that can be nested in the channel. The first signal terminal and the second signal terminal each have a terminal lead on the first end disposed between the ground shield terminal pair, as well as a terminal tail positioned on the second end. Additionally, the connector includes an insulative frame that retains the ground shield and the terminal pair, and a cover plate coupled to the insulative frame. The cover plate can be electrically coupled to the ground shield.

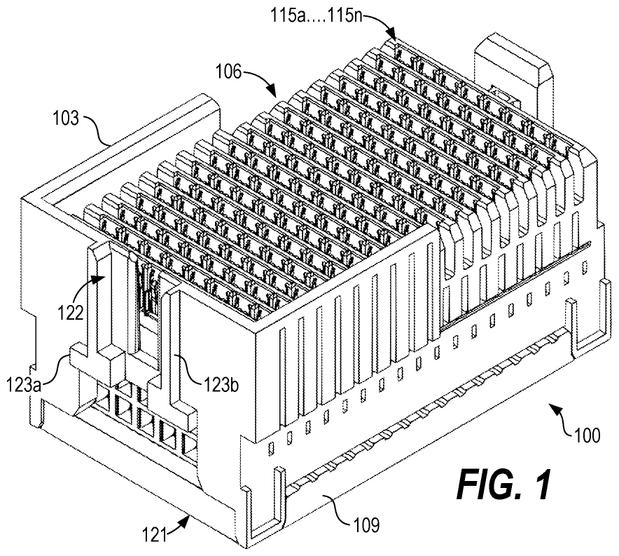

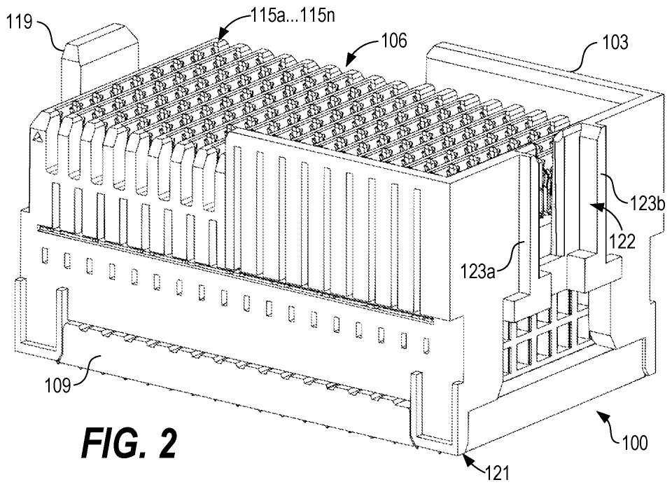

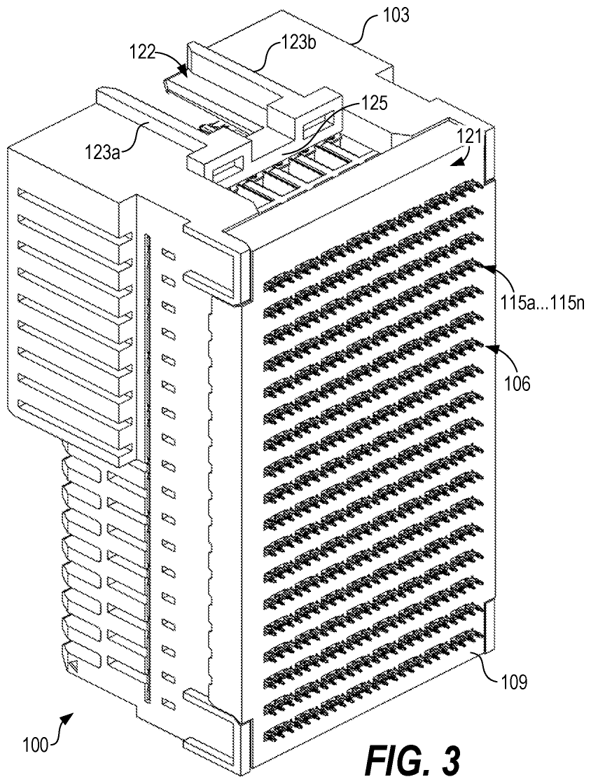

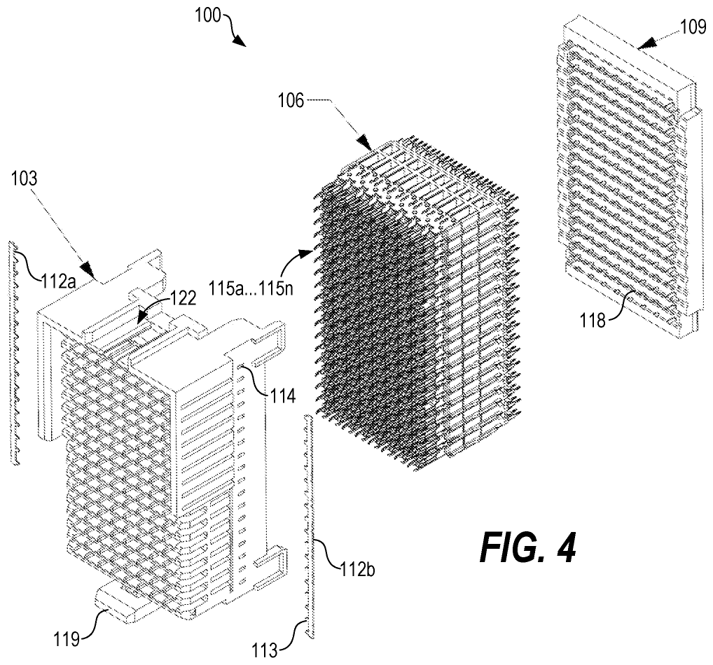

Turning now to the drawings, FIGS. 1-4 illustrate perspective views of an example of a connector 100 according to various embodiments of the present disclosure. Specifically, FIGS. 1 and 2 show opposing top perspective views of the connector 100, whereas FIG. 3 shows a bottom perspective view of the connector 100. Additionally, for explanatory purposes, an exploded view of the connector 100 is shown in FIG. 4.

Referring to FIGS. 1-4 collectively, the connector 100 as illustrated is a representative example and, as such, is not drawn to any particular scale or size. The shape, size, proportion, and other characteristics of the connector 100 may vary as compared to that shown. For example, the connector 100 can accommodate larger or smaller rows of terminals (e.g., be wider or narrower), and other variations are within the scope of the examples described herein. Additionally, one or more of the parts or components of the connector 100, as illustrated in the drawings and described herein, can be omitted in some cases. The connector 100 can also include other parts or components that are not illustrated, as can be appreciated.

Generally, the connector 100 includes a housing 103, a wafer assembly 106, and a ground tail aligner 109, among other components. In various embodiments, the connector 100 can further include retention clips 112a, 112b adapted to be positioned on opposing sides of the housing 103, as shown in FIG. 4. The retention clips 112a, 112b can further retain the wafer assembly 106 relative to the housing 103 and/or the ground tail aligner 109. For instance, the retention clips 112 can include a multitude of projections 113 that are positioned in corresponding apertures 114 positioned on the housing 103, where the projections, as projecting through the apertures 114, engage with and retain the wafer assembly 106 relative to the housing 103.

Referring collectively to FIGS. 1-4, the housing 103 can be configured to support the wafer assembly 106 and can be formed of an insulating material, such as plastic or other suitable material. As such, the housing 103 can be referred to as an insulating housing in some contexts. The ground tail aligner 109 can similarly be formed of an insulating material, such as plastic, plated plastic, or other polymer material, and can have features that help retain a multitude of wafers 115a . . . 115n (collectively “wafers 115”) in the wafer assembly 106 together. For example, the ground tail aligner 109 can include comb projections 118 (FIG. 4) adapted to hold the wafer assembly 106 and/or the wafers 115 thereof in a desired alignment and configuration, as shown in FIGS. 1-3.

The housing 103 can further include a bottom mounting surface 121 adapted to couple to and rest on a surface of a circuit board or other hardware. As may be appreciated, the connector 100 allows for a mechanical and electrical connection between circuit boards (e.g., ICs, PCBs, and the like) via the wafer assembly 106 or more, specifically, the wafers 115 thereof. It can be appreciated that circuit boards can be aligned in a stacked arrangement using the connector 100 in a mezzanine-type arrangement. However, intermediary connectors can be employed that would permit other arrangements, such as orthogonal arrangements, between circuit boards. In any event, when coupled to a circuit board, terminal rows within the housing 103, including terminal conductors among others, will seat upon and make electrical contact with contacts of the circuit board, where the contacts are generally positioned on the top of the circuit board.

The housing 103 can further include a housing clip 119 positioned on a first side of the housing 103 and a housing clip receptacle 122 positioned on a second opposing side of the housing 103. It is understood that the housing clip 119 can engage with a corresponding housing clip receptacle (not shown) of another connector (e.g., a free-end connector, circuit board connector, or other desired connector) to maintain a coupling therebetween. Similarly, the housing clip receptacle 122 can engage with a corresponding housing clip of another connector to maintain a coupling therebetween. The housing clip receptacle 122 can be defined by two projecting sides 123a, 123b and an edge 125. The two projecting sides 123 can have an L-shaped configuration, as shown in FIGS. 1-4; however, it is understood that other configurations can be employed. A housing clip of another connector (not shown) can slide in an engage with the edge 125 via a lip or a projection of the other connector, where the projecting sides 123 can further retain the housing clip, or a portion thereof, therebetween.

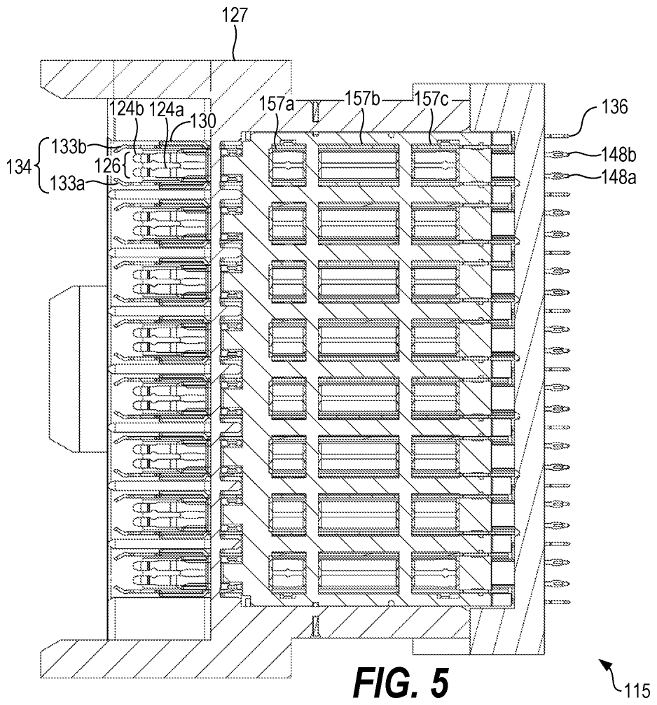

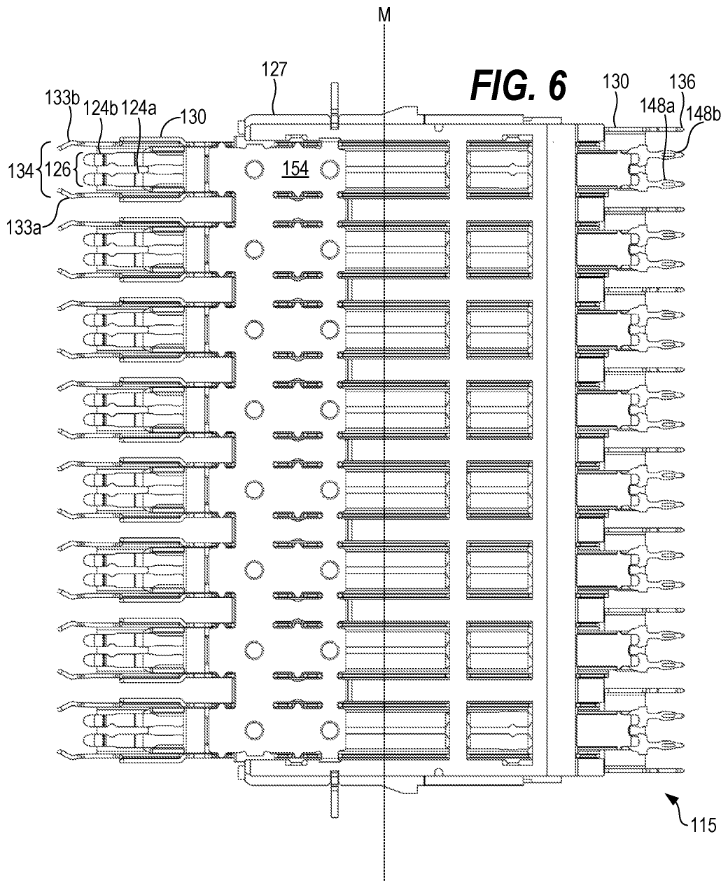

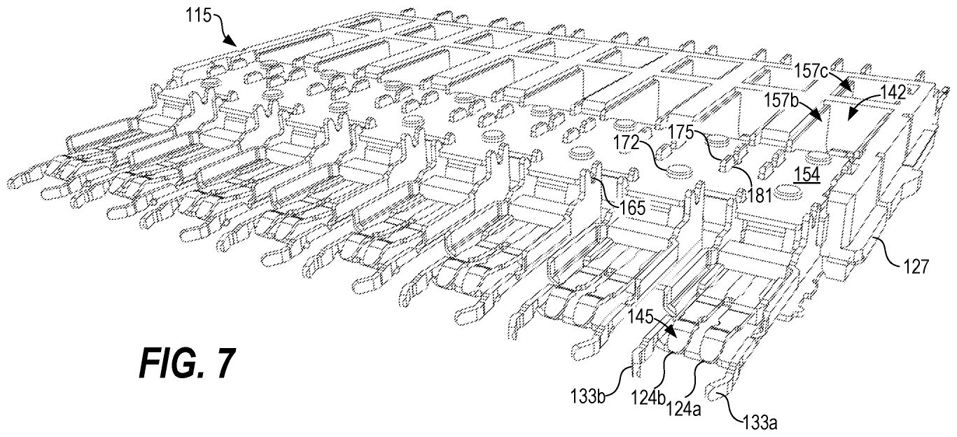

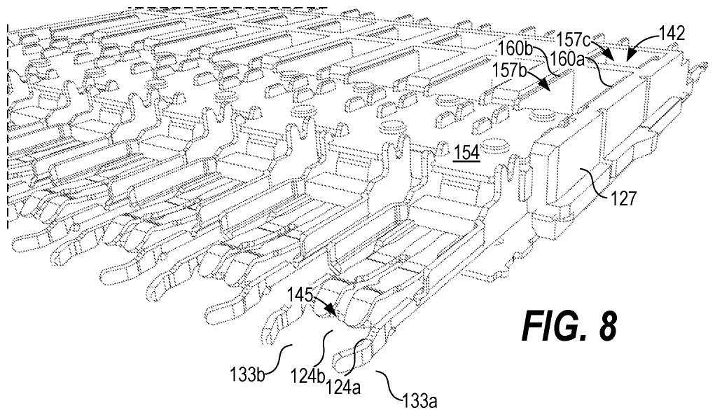

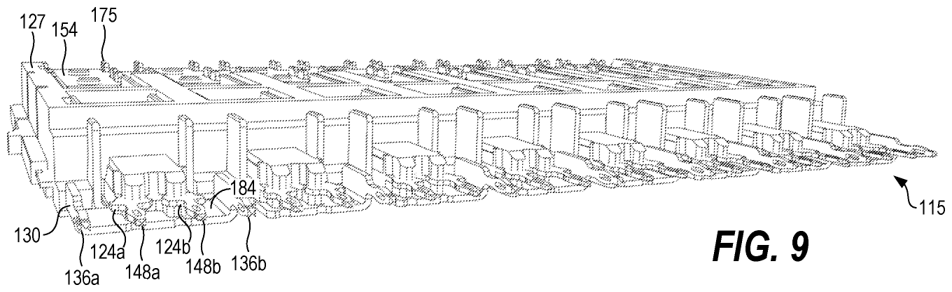

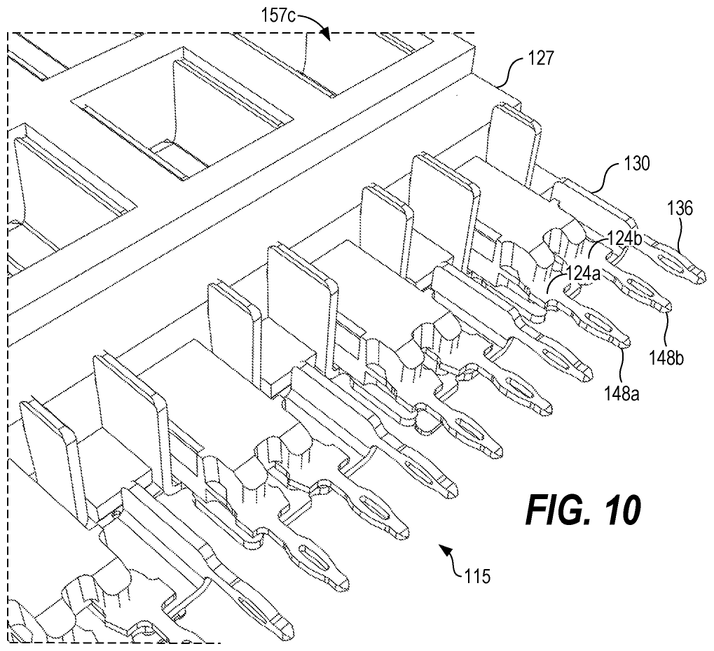

Turning now to FIGS. 5-9, various views of a representative wafer 115 of the wafer assembly 106 are shown according to various embodiments. It is understood that the wafer assembly can include multiple ones of the wafer 115 shown in FIGS. 5-9. For instance, multiple ones of the wafer 115 shown in FIGS. 5-9 can be stacked together in a vertical arrangement, as shown in the exploded view of the connector 100 seen in FIG. 4. Specifically, FIG. 5 shows a top cross-section view of the wafer 115, FIG. 6 shows a top plan view of the wafer 115, FIGS. 7 and 8 show enlarged front perspective views of the wafer 115, and FIGS. 9 and 10 show enlarged rear perspective views of the wafer 115 according to various embodiments.

Referring collectively to FIGS. 5-10, the wafer 115 can include signal terminals 124a, 124b that together form a terminal pair 126. Each of the signal terminals 124a, 124b can be formed of a conductive material, such as copper or other suitable conductive material. The terminal pairs 126 can thus be stamped or sheered from a metal, conductive lead frame. In some embodiments, the retention clips 112 can be stamped from the lead frame at the same time as the terminal pairs 126.

Each terminal pair 126 can be supported by an insulative frame 127, where the insulative frame 127 can again be formed of plastic or other insulating material. Further, each terminal pair 126 can be nested within or otherwise positioned relative to a ground shield 130, where the ground shield 130 is supported or otherwise retained by the insulative frame 127. The insulative frame 127 may be formed by injection molding or like process, as can be appreciated. The ground shield 130 can similarly be formed of a conductive material.

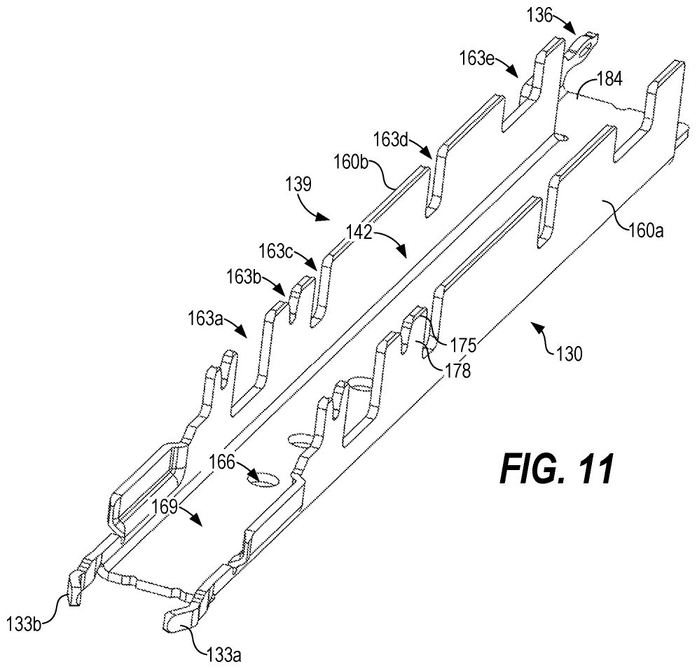

Briefly, an enlarged perspective view of the ground shield 130 is shown in FIG. 11. The ground shield 130 includes a longitudinally extending body having ground contact leads 133a, 133b that together form a ground terminal pair 134. Further, the ground shield 130 includes a ground shield tail 136 and a body 139 that extends between the contact leads 133 and the ground shield tail 136. When the signal terminals 124a, 124b are nested within a U-shaped channel 142 of the ground shield 130, the ground contact terminals 133a, 133b can be positioned on external sides of the signal terminals 124a, 124b such that the signal terminals 124a, 124b are nested therebetween. While the ground shield 130 shown in FIG. 11 shows a single ground shield tail 136, in some embodiments, the ground shield 130 can include two ground shield tails 136a, 136b, as can be seen in on a left-most ground shield 130 shown in FIG. 9. While embodiments described herein relate to a U-shaped channel 142, it is understood that other shaped channels may be similarly employed, such as a V-shaped channel and so forth.

Referring back to FIGS. 5-10 collectively, the signal terminals 124a, 124b each include a terminal lead 145, a terminal tail 148, and a body 151 that extends therebetween. For instance, in FIG. 9, terminal tails 148a, 148b of a left-most terminal pair 126 are shown. The bodies 151 of the signal terminals 124a, 124b can be coupled together in some embodiments to form a differential pair for differential signaling, as can be appreciated. Alternatively, the insulative frame 127 can retain the bodies 151 of the signal terminals 124a, 124b in a parallel but separate arrangement to form the differential pair. In any event, the insulative frame 127 is configured to support a multitude of terminal pairs 126, such as eight or more such pairs. However, it is understood that other numbers of terminal pairs 126 may be employed depending on a desired specification. As noted above, each terminal pair 126 has a body 151 of two terminals aligned in an edge-to-edge configuration so that spacing of the terminals can be carefully controlled when the terminals 124 are stamped, molded, or otherwise formed into the wafer 115.

As shown in the top plan view of FIG. 6, the wafer 115 can further include a cover plate 154. The cover plate 154 can be formed of a conductive material in various embodiments and can add stability and rigidity to the overall construction of the wafer 115. Additionally, as the cover plate 154 is conductive, the cover plate 154 can provide electrical isolation, thereby improving signal quality offered by the terminal pairs 126. The cover plate 154 can be positioned between the ends of the terminal pair 126 and, in some embodiments, can have a width less than a width of the terminal pairs 126. To reduce an amount of material required to provide the cover plate 154, and as a larger cover plate body than that shown in FIG. 6 does not provide significant improvements in signal isolation, the cover plate 154 can be positioned laterally or offset with respect to a midpoint M such that the cover plate 154 is positioned closer to the terminal lead 145 of each terminal pair 126 as compared to the tail end of the wafer 115. In some embodiments, the cover plate 154 can at least partially cover apertures 157a . . . 157c (collectively “apertures 157”) that are collectively defined by the shape of the body of the ground shield 130 and the insulative frame 127, thereby preventing signal degradation that can occur due to one or more of the apertures 157.

The ground shield 130 can be mounted to the insulative frame 127. Additionally, the ground shield 130 can provide the U-shaped channel 142. Referring again to FIG. 11, the U-shaped channel 142 can be defined by side walls 160a, 160b where the terminal pairs 126 are positioned between the side walls 160a, 160b. As can be appreciated, the ground shield 130 provides broad-side coupling to the terminal pairs 126 and provides a return path while also helping to shield the terminal pairs 126 from adjacent terminal pairs 126 in the same wafer 115 and in adjacent wafers 115. When positioned in the insulative frame 127, the side walls 160a, 160b can protrude slightly above a top surface of the insulative frame 127, may extend to an area slightly below a top surface of the insulative frame 127, or may be substantially flush with the top surface of the insulative frame 127.

The ground shield 130 can further include a multitude of notches 163a . . . 163e (collectively “notches 163”) symmetrically opposed from one another, where the notches 163 include cut-out sections provided in the side walls 160 of the ground shield 130. The notches 163 can include areas that retain portions of the cover plate 154, such as laterally extending protrusions 165 of the cover plate 154, that can form a physical and an electrical coupling therebetween in some embodiments. Similarly, the notches 163 can retain portions of the insulative frame 127 to form a physical coupling therebetween. Further, the cover plate 154 can be positioned above a first one of the notches 163a (or a portion of the notches 163 positioned laterally with respect to midpoint M) to account for potential interference arising from the large U-shape cutout of the first one of the notches 163a in the two side walls 160. As can be appreciated, the U-shaped channel 142 thus provides a three-sided shield for the terminal pair 126 from the tail to the contact in a substantially continuous manner.

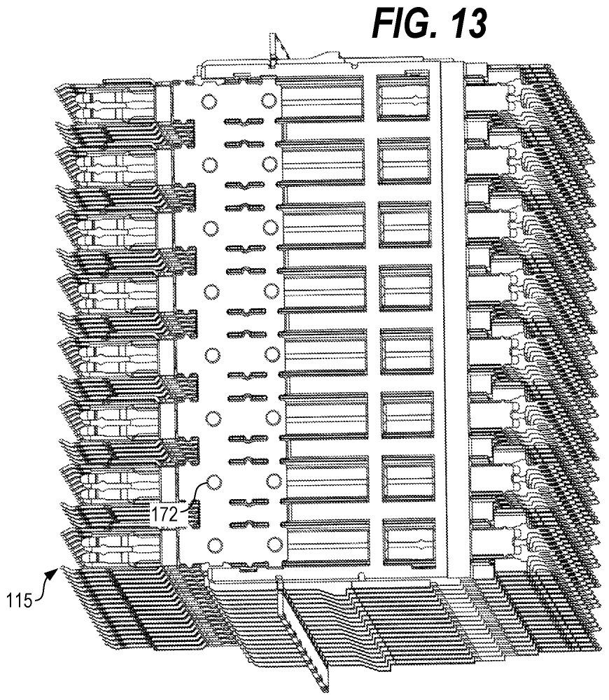

Even further, the ground shield 130 can include one or more apertures 166 positioned on a bottom surface 169 of the ground shield 130. To couple the ground shield 130 to the insulative frame 127, the insulative frame 127 can include a multitude of projections 172 that form an interference, friction, or like fit with a corresponding one of the apertures 166. The apertures 166 and/or the projections 172 can be similarly and correspondingly shaped, such as circular-shaped as shown in FIG. 11 and FIG. 13. Alternatively, the apertures 166 and/or the projections 172 can be ovular-shaped, square-shaped, triangular-shaped, star-shaped, rectangular-shaped, and so forth.

The ground shield 130 can further include side wall projections 175. The side wall projections 175 can be positioned on a top surface of vertically extending members 178, where the vertically extending members 178 includes areas of the ground surface on opposing sides of a notch 163, as shown in FIG. 11. The side wall projections 175 can protrude through corresponding apertures 181 of the cover plate 154, best shown in FIG. 7, furthering the coupling and the electrical coupling (and grounding effect) between the ground shield 130 and the cover plate 154.

As best seen in the rear perspective view of the wafer 115 shown in FIG. 9, the signal terminals 124a, 124b are not directly positioned on the bottom surface 169 of the U-shaped channel 142. However, they are slightly raised from the bottom surface 169 while maintaining a close distance. Due to the compact arrangement of the signal terminals 124a, 124b relative to the ground shield 130, additional wafers 115 can be added to the connector 100 and/or additional terminal pairs 126 can be implemented in the connector 100 without substantially increasing the size of the connector 100.

In various implementations, the connector 100 can be a hermaphroditic connector such that a separate and identical connector is able to align with and connect to the connector 100 shown in FIG. 1. For instance, as noted above, the housing 103 can include a housing clip 119 positioned on a first side of the housing 103 and a housing clip receptacle 122 positioned on a second opposing side of the housing 103. It is understood that the housing clip 119 can engage with a housing clip receptacle (not shown) of another hermaphroditic connector to maintain a coupling therebetween. Similarly, the housing clip receptacle 122 can engage with a corresponding housing clip of the other hermaphroditic connector to maintain a coupling therebetween. In various implementations, the connector 100 is capable of handing 112 Gb transmissions while still being low cost and relatively easy to manufacture.

Referring again to FIG. 9, it can be seen that, in a first portion of the terminal pairs 126 (e.g., the right-most seven terminal pairs 126), the ground shield tail 136 is a single ground shield tail corresponding to signal terminals 124a, 124b or, more specifically, the terminal tails 148a, 148b thereof. In other words, the ground shield tail 136 is in a one-to-two correspondence with the terminal tail 148 of the first signal terminal 124a and the second signal terminal 124b. Further, FIG. 9 shows that, in a second portion of the terminal pairs 126 (e.g., the left-most terminal pair 126), the ground shield tail 136a is one of two ground shield tails 136a, 136b. As such, in the second portion of the terminal pairs 126, the ground shield tails 136 are in a two-to-two correspondence with the terminal tail 148 of the first signal terminal 124a and the second signal terminal 124b. The ground shield tail 136 extends rearwardly off a laterally-extending platform 184 relative to a rear portion of the ground shield 130. As such, each of the ground shield tails 136, the terminal tails 148a, and the terminal tails 148b are in line with one another.

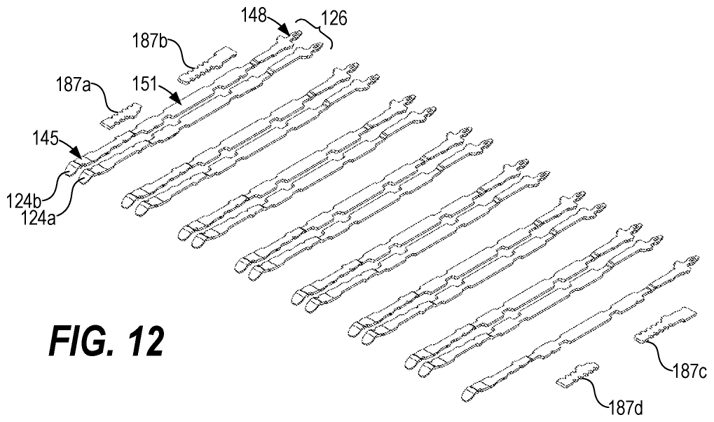

Turning again to FIG. 12, the wafer 115 can include one or more connecting members 187a . . . 187d (collectively “connecting members 187” or “conductive connecting members”). To facilitate manufacture of the wafer 115, the connecting members 187 can be formed from a same lead frame as the terminal pairs 126, the retention clips 112, and/or other components formed from a lead frame. As such, the connecting members 187 can be conductive and formed of copper or other conductive material, as can be appreciated.

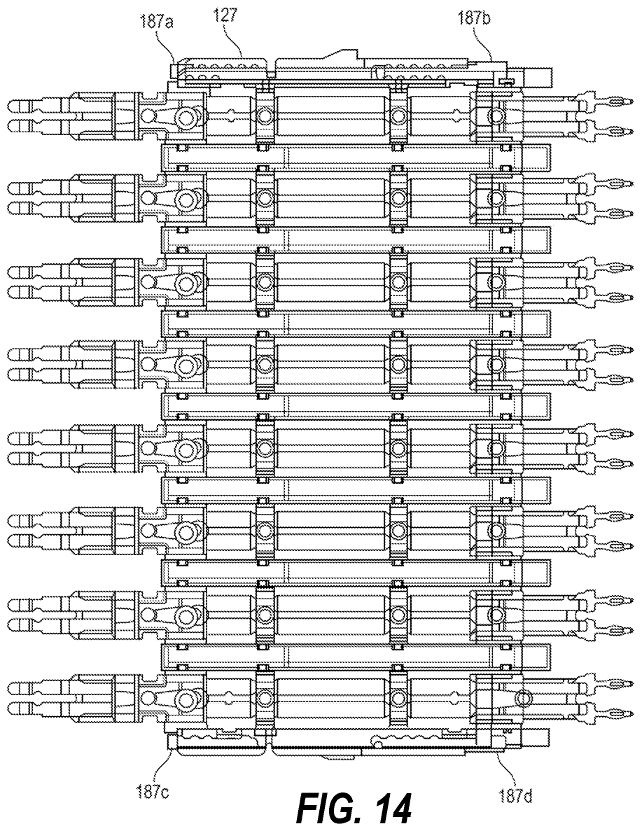

As shown in FIG. 12, the connecting members 187 can be separate from the terminal pair 126 or a connection between the connecting members 187 and an outer-most signal terminal 124 can exist. In any event, the connecting members 187 are positioned parallel to the terminal pairs 126. The connecting members 187 include one or more scalloped sides having a plurality of teeth or projections configured to engage with corresponding teeth of the insulative frame 127 during an injection mold process, for example, the insulative frame 127. FIG. 14 is a transparent view showing an interference connection between teeth of the insulative frame 127 and teeth of the connecting members 187. A first portion of the plurality of connecting members 187 (e.g., connecting members 187a, 187b) are positioned outside of and parallel to a first distal one of the terminal pairs 126, and a second portion of the plurality of connecting members 187 (e.g., connecting members 187c, 187d) are positioned outside of and parallel to a second distal one of the terminal pairs 126.

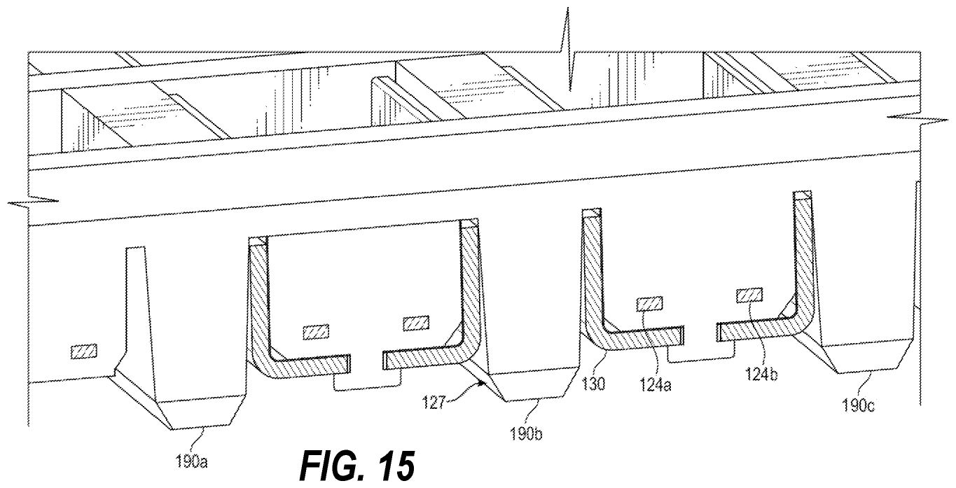

Moving along to FIG. 15, an enlarged cross-section of a rear portion of the wafer 115 is shown. In FIG. 15, the insulative frame 127 is shown extending into the U-shaped channel 142 such that the signal terminals 124a, 124b are each encapsulated by the insulative frame 127. As such, the insulative frame 127 maintains the signal terminals 124a, 124b a predetermined distance above the bottom surface 169 of the ground shield 130 and a predetermined distance from each side wall 160 of the ground shield 130. Also, insulative frame 127 maintains each of the signal terminals 124a, 124b a predetermined distance from one another. The insulative frame 127 further includes separation members 190 extending downwardly relative to a body of the insulative frame 127, where the separation members 190 are positioned between adjacent ground shields 130. The separation members 190 may provide further electrical and signal isolation, as can be appreciated. The separation members 190 may extend below the bottom surface 169 of the ground shield 130.

The connector 100 can incorporate further features that provide additional support, rigidity, and other benefits to maintain electrical connections and data communication integrity between terminal conductors within the connector 100 and contacts in a connector that, for example, mate with the connector 100. The connector 100 can be designed for use with mezzanine interconnection systems, although the connector support structure concepts described herein are not limited to use with any particular type or style of interconnect system.

The features, structures, or characteristics described above may be combined in one or more embodiments in any suitable manner, and the features discussed in the various embodiments are interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” “third,” etc. are used only as labels, rather than a limitation for a number of the objects. It is understood that if multiple components are shown, the components may be referred to as a “first” component, a “second” component, and so forth, to the extent applicable.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. An electrical connector, comprising:
a wafer assembly comprising a plurality of wafers, wherein at least one of the plurality of wafers comprises:
a ground shield having side walls that define a channel, the ground shield comprising a first ground shield terminal lead and a second ground shield lead terminal that together form a ground shield terminal pair positioned at a first end of the at least one of the wafers, and a ground shield tail positioned at a second end of the at least one of the wafers;
a first signal terminal and a second signal terminal together forming a terminal pair nested in the channel, the first signal terminal and the second signal terminal each having a terminal lead at the first end disposed between the ground shield terminal pair, and a terminal tail positioned at the second end;
an insulative frame that retains the ground shield and the terminal pair; and
a cover plate electrically coupled to the ground shield and extending over the channel.

2. The electrical connector according to claim 1, wherein the channel is a U-shaped channel, the cover plate is positioned laterally with respect to a midpoint of one of the plurality of wafers, and the insulative frame and the U-shaped channel together define a plurality of apertures.

3. The electrical connector according to claim 2, wherein the cover plate covers at least one of the plurality of apertures.

4. The electrical connector according to claim 3, wherein the at least one of the plurality of apertures covered by the plurality of apertures is a respective aperture closest to the terminal lead of the terminal pair.

5. The electrical connector according to claim 1, wherein the ground shield tail is a single ground shield tail in a one-to-two correspondence with the terminal tail of the first signal terminal and the second signal terminal.

6. The electrical connector according to claim 1, wherein:
the terminal pair is one of a plurality of terminal pairs;
the ground shield is one of a plurality of ground shields;
in a first portion of the terminal pairs, the ground shield tail of the plurality of ground shields is a single ground shield tail in a one-to-two correspondence with the terminal tail of the first signal terminal and the second signal terminal; and
in a second portion of the terminal pairs, the ground shield tail of the plurality of ground shields is one of two ground shield tails in a two-to-two correspondence with the terminal tail of the first signal terminal and the second signal terminal.

7. The electrical connector according to claim 1, wherein the insulative frame comprises a plurality of projections that form an interference fit or a friction fit with a plurality of apertures positioned on a bottom surface of the ground shield.

8. The electrical connector according to claim 1, wherein the at least one of the plurality of wafers further comprises:
a connecting member separate from the terminal pair positioned parallel to the terminal pair, wherein the connecting member comprises a plurality of teeth configured to engage with corresponding teeth of the insulative frame.

9. The electrical connector according to claim 8, wherein the connecting member is one of a plurality of connecting members.

10. The electrical connector according to claim 9, wherein the terminal pair is one of a plurality of terminal pairs, and a first portion of the plurality of connecting members are positioned outside of and parallel to a first distal one of the terminal pairs, and a second portion of the plurality of connecting members are positioned outside of and parallel to a second distal one of the terminal pairs.

11. The electrical connector according to claim 1, wherein the connector is a hermaphroditic connector configured to detachably attach to another connector separate from and identical to the connector.

12. The electrical connector according to claim 1, wherein the insulative frame extends into the channel such that the signal terminals are each encapsulated by the insulative frame, wherein the insulative frame maintains the signal terminals a predetermined distance above a bottom surface of the ground shield and a predetermined distance from side walls of the ground shield.

13. The electrical connector according to claim 12, wherein the insulative frame maintains each of the signal terminals a predetermined distance from one another.

14. The electrical connector according to claim 1, wherein the insulative frame further comprises separation members extending downwardly relative to a body of the insulative frame, wherein the separation members are positioned between the ground shield and another adjacent ground shield.

15. The electrical connector according to claim 14, wherein the separation members extend downwardly below a bottom surface of the ground shield.

16. An electrical connector, comprising:
at least one wafer, the at least one wafer comprising a first signal terminal and a second signal terminal together forming a terminal pair, the first signal terminal and the second signal terminal each having a terminal lead at a first end of the at least one wafer, and a terminal tail positioned at a second end of the at least one wafer opposite the first end; and
a ground shield having side walls that define a U-shaped channel in which the terminal pair are nested, the ground shield comprising a first ground shield terminal lead and a second ground shield lead terminal that together form a ground shield terminal pair positioned at the first end of the at least one of the wafers, and a ground shield tail positioned at the second end of the at least one of the wafers;
wherein the ground shield comprises sidewalls having a multitude of notches symmetrically opposed from one another, wherein the notches are cut-out sections provided in the side walls, the notches being configured to engage and retain an insulative frame and a cover plate to the at least one wafer.

17. The electrical connector according to claim 16, wherein the cover plate is positioned laterally with respect to a midpoint of the at least one wafer, the insulative frame and the U-shaped channel together define a plurality of apertures, and the cover plate covers at least one of the plurality of apertures.

18. The electrical connector according to claim 17, wherein the at least one of the plurality of apertures covered by the plurality of apertures is a respective aperture closest to the terminal lead of the terminal pair.

19. The electrical connector according to claim 16, wherein:
the terminal pair is one of a plurality of terminal pairs;
the ground shield is one of a plurality of ground shields;
in a first portion of the terminal pairs, the ground shield tail of the plurality of ground shields is a single ground shield tail in a one-to-two correspondence with the terminal tail of the first signal terminal and the second signal terminal; and
in a second portion of the terminal pairs, the ground shield tail of the plurality of ground shields is one of two ground shield tails in a two-to-two correspondence with the terminal tail of the first signal terminal and the second signal terminal.

20. The electrical connector according to claim 16, wherein:
the at least one wafer further comprises a connecting member separate from the terminal pair positioned parallel to the terminal pair, wherein the connecting member comprises a plurality of teeth configured to engage with corresponding teeth of the insulative frame;
the terminal pair is one of a plurality of terminal pairs;
a first portion of the plurality of connecting members are positioned outside of and parallel to a first distal one of the terminal pairs; and
a second portion of the plurality of connecting members are positioned outside of and parallel to a second distal one of the terminal pairs.
